(19) United States
(12) Patent Application Publication
(10) Pub. No.: US 2017/0094132 A1
(43) Pub. Date: Mar. 30, 2017

(54) IMAGE CAPTURE APPARATUS, DETERMINATION METHOD, AND STORAGE MEDIUM DETERMINING STATUS OF MAJOR OBJECT BASED ON INFORMATION OF OPTICAL ABERRATION

(71) Applicant: CASIO COMPUTER CO., LTD., Tokyo (JP)

(72) Inventor: Akira Miyata, Tokyo (JP)

(21) Appl. No.: 15/223,451

(22) Filed: Jul. 29, 2016

(30) Foreign Application Priority Data
Sep. 30, 2015 (JP) 2015-193571

(51) Int. Cl. H04N 5/217; H04N 5/225; H04N 5/232

(52) U.S. Cl. CPC H04N 5/2171; H04N 5/23219; H04N 5/23238; H04N 5/23245; H04N 5/2252; H04N 5/23222

(57) ABSTRACT

To determine a state of an object appropriate for shooting. The image capture apparatus is provided with: the image capture unit; the shooting information acquisition unit; the major object identification unit; and the positional relationship determination unit. The image capture means captures an image of an object. The shooting information acquisition unit acquires information relating to optical aberration in the image capture unit. The major object identification unit identifies the major object in the image captured by the image capture unit. A status of the major object identified by the major object identification unit is determined based on the information relating to optical aberration acquired by the positional relationship determination unit and the shooting information acquisition unit.

### CROSS-REFERENCE TO RELATED APPLICATION

This application is based upon and claims the benefit of priority under 35 USC 119 of Japanese Patent Application No. 2015-193571 filed on Sep. 30 2015 the entire disclosure of which, including the description, claims, drawings, and abstract, is incorporated herein by reference in its entirety.

### BACKGROUND OF THE INVENTION

Field of the Invention

The present invention relates to an image capture apparatus, determination method, and storage medium that determine a status of a major object based on information of optical aberration.

Related Art

As disclosed in Japanese Patent Application Publication No. 2011-55361, a technology of preventing light falloff and clipping of a region of large optical aberration in an image capture apparatus has been conventionally known.

### SUMMARY OF THE INVENTION

An image capture apparatus according to an aspect of the present invention includes:

a processor which is configured to:

capture an image of an object;

acquire information relating to optical aberration in the image capture unit;

identify a major object in an image captured by the image capture unit; and

determine a status of the major object based on the information relating to optical aberration.

Furthermore, a determination method according to an aspect of the present invention is

a determination method performed by an image capture apparatus provided with an image capture unit that captures an image of an object, the method comprising:

acquiring information relating to optical aberration in the image capture unit;

identifying a major object from an image captured by the image capture unit; and

determining a status of the major object based on the information relating to optical aberration.

Furthermore, a storage medium according to an aspect of the present invention is

a non-transitory computer readable storage medium encoded with a computer-readable program that enables a computer to execute functions comprising: acquiring information relating to optical aberration in the image capture unit;

identifying a major object from an image captured by the image capture unit; and

determining a status of the major object based on the information relating to optical aberration.

### BRIEF DESCRIPTION OF THE DRAWINGS

FIG. 1A is a schematic view illustrating a positional relationship between an image capture apparatus and a user in a handheld selfie shooting state according to an embodiment of the present invention;

FIG. 1B is a schematic view illustrating an external appearance of the image capture apparatus in a stationary shooting state according to an embodiment of the present invention;

FIG. 1C is a schematic view illustrating an external appearance and a shooting function of the image capture apparatus in the positional relationship between the image capture apparatus and the user illustrated in FIG. 1A;

FIG. 1D is a schematic view illustrating an external appearance and a shooting function of the image capture apparatus illustrated in FIG. 1B;

FIG. 2 is a block diagram illustrating a hardware configuration of the image capture apparatus according to an embodiment of the present invention;

FIG. 3 is a schematic view illustrating a specific example of an output in the case of a determination result being non-preferable;

FIG. 4 is a functional block diagram illustrating a functional configuration for performing a shooting process among functional configurations of the image capture apparatus of FIG. 2;

FIG. 5 is a flow chart explaining a flow of the shooting process performed by the image capture apparatus of FIG. 2 having the functional configuration of FIG. 4; and

FIG. 6 is a flow chart explaining a flow of a shooting process, which is different from the shooting process illustrated in FIG. 5, performed by the image capture apparatus of FIG. 2 having the functional configuration of FIG. 4.

### DETAILED DESCRIPTION OF THE INVENTION

An embodiment of the present invention is described hereinafter with reference to the drawings.

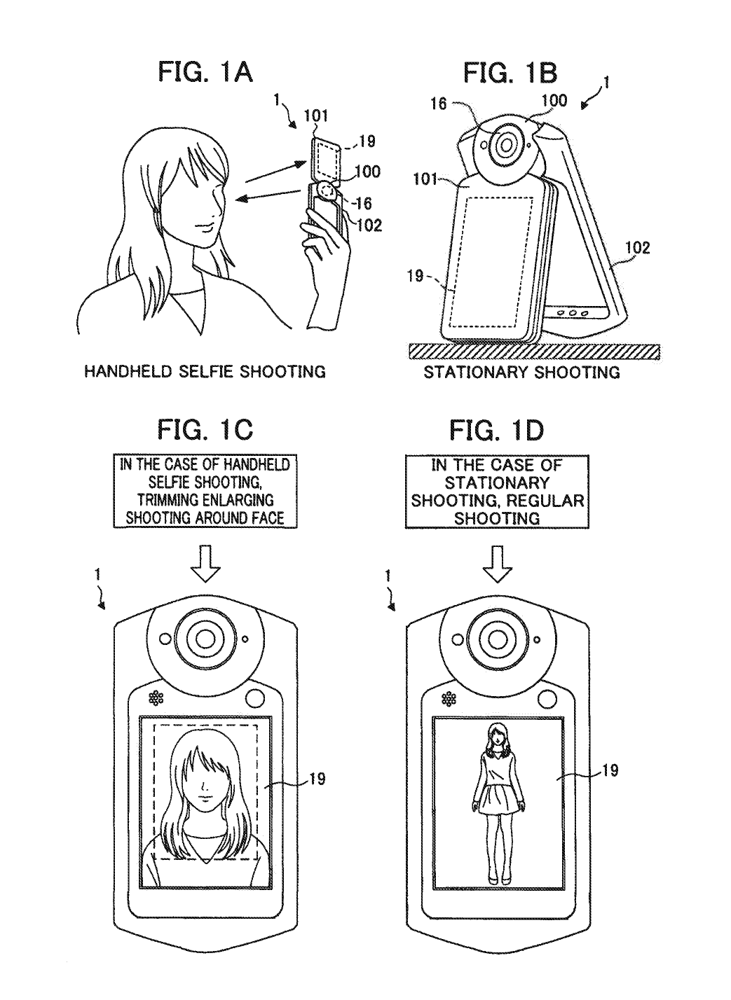

FIG. 1 is a schematic view illustrating an external appearance and a shooting function of an image capture apparatus according to an embodiment of the present invention.

An image capture apparatus 1 of the present embodiment is, as illustrated in FIGS. 1A and 1B, composed of a first housing 100, a second housing that is connected to the first housing 100; and a frame 102 connected to the first housing 100.

The first housing 100 has an image capture unit 16 (described later in detail) and a lens face is configured on one side as a shooting direction.

The second housing 101 has an output unit 19 (described later in detail) and a display is configured on one side as a display direction.

In addition, the second housing 101 is connected to the first housing 100 so as to be rotatable to a lens face side and to a non-lens face side.

That is, by rotating the second housing 101 with respect to the first housing 100, the shooting direction and the display direction can be switched.

In the case of the shooting direction being also the display direction in the first housing 100 and the second housing 101, the image capture apparatus 1 allows shooting while a user checks his/her image on the output unit 19, so-called selfie shooting.

A frame 102 is connected to the first housing 100 so as to be rotatable with respect to the first housing 100 and the second housing 101 to a shooting direction (display direction) and to a non-shooting direction (non-display direction).

Since the frame 102 is configured to be rotatable to the shooting direction (display direction) and to the non-shooting direction (non-display direction), a user can shoot a selfie while holding the frame 102 (hereinafter referred to as “handheld selfie shooting”) as illustrated in FIG. 1A. Likewise, the user can also shoot with the frame 102 and an end portion of the second housing 101 as an installation face (hereinafter referred to as “stationary shooting”) as illustrated in FIG. 1B.

The determination of handheld selfie shooting or stationary shooting can be made by either a manual setting by the user or automatic detection based on sensing information from a sensor unit 17 (described later in detail).

In addition, the image capture apparatus 1 according to the present embodiment has a function of generating an image by trimming and enlarging a desired region (for example, human face) of the shot image (hereinafter referred to as a “trimmed enlarged image”).

“Trimming enlarging shooting” refers to an operation from shooting to obtaining the trimmed enlarged image from the image thus shot by the function.

On the other hand, shooting which does not involve the trimming enlarging shooting is referred to as “regular shooting”.

The image capture apparatus 1 according to the present embodiment performs the trimming shooting in the case of the handheld selfie shooting as illustrated in FIG. 1C, and the regular shooting in the case of the stationary shooting as illustrated in FIG. 1D.

If the user has made a setting for performing the selfie shooting, the apparatus is configured to perform the trimming enlarging shooting even in the case of stationary shooting.

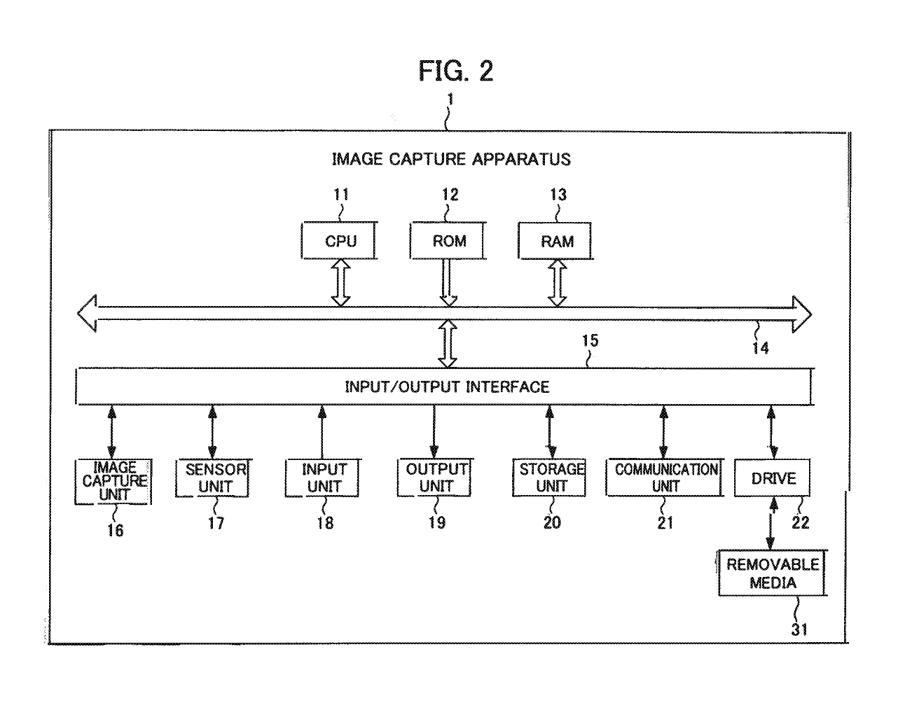

FIG. 2 is a block diagram illustrating a hardware configuration of the image capture apparatus 1 according to an embodiment of the present invention.

The image capture apparatus 1 is configured as, for example, a digital still camera.

The image capture apparatus 1 includes, as illustrated in FIG. 2, a CPU (Central Processing Unit) 11, ROM (Read Only Memory) 12, RAM (Random Access Memory) 13, a bus 14, an input/output interface 15, the image capture unit 16, the sensor unit 17, an input unit 18, an output unit 19, a storage unit 20, a communication unit 21, and a drive 22.

The CPU 11 executes various processes in accordance with a program stored in the ROM 12 or a program loaded from the storage unit 20 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 18, the output unit 19, the storage unit 20, the communication unit 21, and the drive 22 are connected to the input/output interface 15.

The image capture unit 16 includes an optical lens unit and an image sensor, which are not shown.

In order to photograph a subject, the optical lens unit is configured by a lens such as a focus lens and a zoom lens for condensing light. The focus lens is a lens for forming an image of a subject on the light receiving surface of the image sensor.

The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example.

Light incident through the optical lens unit forms an image of a subject in the optoelectronic conversion device.

The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal and image data is output as an output signal from the image capture unit 16.

The image data is supplied to the CPU 11, an image processing unit (not illustrated), and the like as appropriate.

The image capture unit 16 of the present embodiment is configured to allow shooting using a lens allowing a wide-angle shot (hereinafter referred to as “wide-angle lens”).

The sensor unit 17 is composed of a sensor that can detect an attitude of the apparatus, for example, a three-axis geomagnetic sensor, a three-axis acceleration sensor, a gyro sensor, etc.

The input unit 18 is configured by various buttons, etc. and inputs various information in response to the instruction operations of the user.

The output unit 19 is composed of a display, a speaker, an LED (Light Emitting Diode) lamp, a vibrator, etc. and is configured to be able to output an image, sound, light, and vibration.

The storage unit 20 is configured by DRAM (Dynamic Random Access Memory) or the like, and stores data of various images.

The communication unit 21 controls communication to be performed with another device (not illustrated) via a network including the Internet.

A removable medium 31 composed of a magnetic disk, an optical disk, a magneto-optical disk, semiconductor memory or the like is installed in the drive 22, as appropriate. A program read from the removable media 31 by the drive 22 is installed in the storage unit 20 as necessary. In addition, similarly to the storage unit 20, the removable media 31 can store various data such as the data of images stored in the storage unit 20.

The image capture apparatus 1 thus configured has a function of, in selfie shooting using the wide-angle lens, facilitating shooting at a position at which a face, which is an object, is not affected by distortion of the lens.

The wide-angle lens has a characteristic of distorting the object in a short distance. In addition to the lens characteristic of the wide-angle lens, various lenses have a common lens characteristic of distorting as approaching to a specific position (for example, any of four corners) in an angle of view. In other words, the wide-angle lens causes more distortion with an object in a shorter distance and closer to any of the four corners. It should be noted that in the case of the wide-angle lens, a degree of distortion depends more on the distance than on the position in the angle of view.

Given this, the image capture apparatus 1 of the present embodiment determines whether an object (hereinafter referred to as “major object”), which is a target of the selfie shooting (in the present embodiment, a face) is in a state unaffected by the characteristic of the wide-angle lens being installed. The state unaffected by the characteristic of the wide-angle lens refers to, for example, a state in which the major object is at a large distance or near the center of the angle of view.

Given a result of the determination, the image capture apparatus 1 performs shooting assistance such as notification of the determination result, and performs automatic shooting in the case of the determination result being preferable.

On the contrary, in the case of the determination result being not preferable, an output is made for leading to an appropriate state for shooting, by notifying of an inappropriate state for shooting, or by suggesting the appropriate state for shooting by, for example, highlighting the distortion.

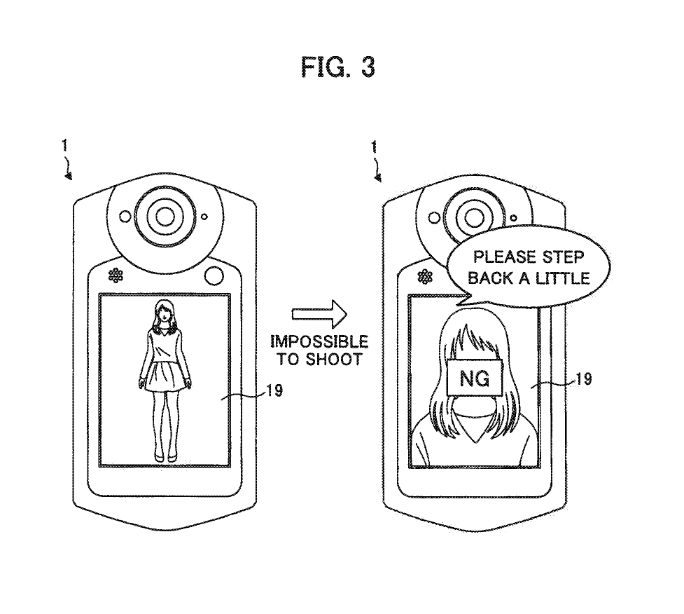

FIG. 3 is a schematic view illustrating a specific example of an output in the case of a determination result being non-preferable;

In a specific example, in the case of the determination result being not preferable, “NG” is displayed for notifying of the inappropriate state for shooting, as illustrated in FIG. 3.

In addition, in order to suggest the appropriate state for shooting, an announcement by sound, such as “Please step back a little”, is output.

Another example can be configured to perform forced trimmed display, or to display a text or an icon such as “Please move the camera away” and “Too close”. The invention can also be configured: to output a sound alert such as “Please move the camera away” or an error beep; to display a face-shaped semi-transmissible guide for facilitating alignment of the face; to display a grid or a frame for clearly informing size and position of the face; and the like.

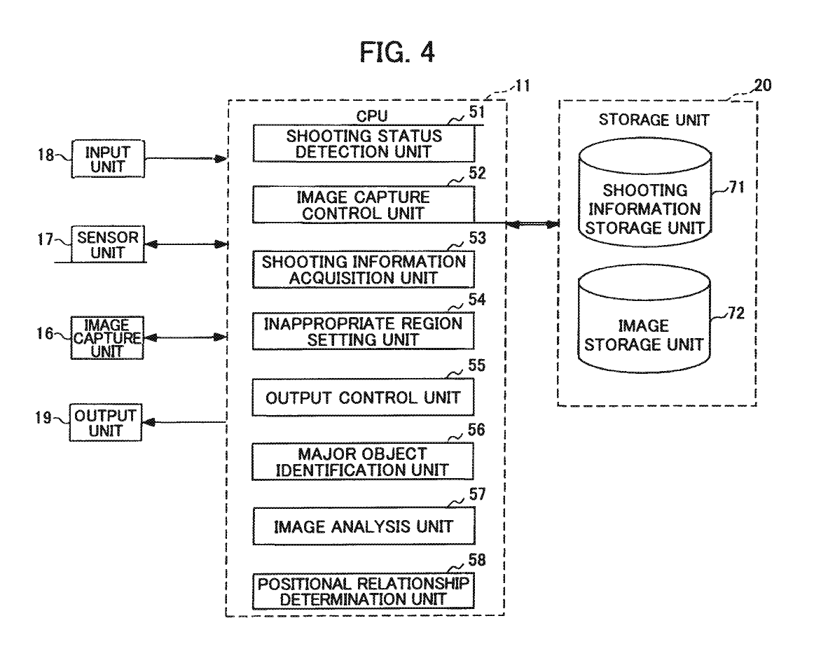

FIG. 4 is a functional block diagram showing a functional configuration for executing a shooting process, among the functional configurations of the image-capture device 1.

The shooting process refers to a series of processes for determining a positional relationship between the major object being identified and a region inappropriate for shooting being set (hereinafter referred to as an “inappropriate region for shooting”) to thereby control shooting during live view shooting.

Upon executing the shooting process, a shooting status detection unit 51, an image capture control unit 52, a shooting information acquisition unit 53, an inappropriate region setting unit 54, an output control unit 55, a major object identification unit 56, an image analysis unit 57, and a positional relationship determination unit 58 function in the CPU 11, as illustrated in FIG. 4.

In addition, a region of the storage unit 20 is provided with a shooting information storage unit 71 and an image storage unit 72.

The shooting information storage unit 71 stores shooting information including a lens characteristic derived from lens performance of the wide-angle lens being installed, and information of current shooting status (e.g. object distance and focal length). As the lens characteristic of the wide-angle lens, the distance from the lens causing distortion is calculated based on the lens performance (specification etc.) in advance, and stored in the shooting information storage unit 71 as the shooting information.

The image storage unit 72 stores data of an image acquired by shooting.

The shooting status detection unit 51 detects the shooting status of the image capture apparatus 1.

For example, the shooting status detection unit 51 detects whether the shooting is stationary shooting or handheld selfie shooting, based on user setting or sensor information (information of attitude of the apparatus) acquired from the sensor unit 17.

The image capture control unit 52 controls the image capture unit 16 to execute the shooting process and to output an image (a live view image or a shot image).

For example, during the shooting process, the image capture control unit 52 stores the object distance and the focal length resulting from the control as the shooting information, sequentially in the shooting information storage unit 71. In addition, the image capture control unit 52 controls the image capture unit 16 to perform automatic shooting. Furthermore, the image capture control unit 52 performs a shooting prohibition process to control the image capture unit 16, to thereby prohibit shooting. In the case of trimming enlarging shooting, the image capture control unit 52 controls to clip a region of the major object from the image output by the image capture unit 16 and to generate a new image by adjusting image size, and stores an image resulting from the shooting process to the image storage unit 72.

The shooting information acquisition unit 53 acquires the shooting information from the shooting information storage unit 71.

For example, the shooting information acquisition unit 53 refers to the shooting information stored in the shooting information storage unit 71 and acquires information such as the lens characteristic derived from the lens performance, as well as the object distance and the focal length resulting from the control of the image capture unit 16.

The inappropriate region setting unit 54 sets the region inappropriate for shooting corresponding to a distance of the object in the current angle of view in the lens performance, based on the object distance acquired from the image capture unit 16 and the lens characteristic.

The region inappropriate for shooting is a region where the object distance, which is determined by the wide-angle lens characteristic, is small, as well as particular regions in the angle of view (four corners of the angle of view).

The output control unit 55 controls the output unit 19 to display the image.

For example, the output control unit 55 makes the output unit 19 output by displaying the region inappropriate for shooting as a guide frame.

In addition, the output control unit 55 controls the output unit 19 to output an announcement of alert or suggestion (shooting assistance) by displaying a message etc. in an overlapping manner on the live view image or the image, as illustrated in FIG. 3.

The major object identification unit 56 performs face recognition on the image by means of an identification unit and skin color detection, to thereby identify the major object, namely a human face, among objects within the angle of view.

By employing the skin color detection, even if a face is in a region suffering from distortion, a facial region can be detected with high precision.

The image analysis unit 57 analyzes the image.

For example, the image analysis unit 57 analyzes the image and thereby determines the position and the size of the region of the major object in the image.

The positional relationship determination unit 58 determines the positional relationship between the major object and the region inappropriate for shooting.

For example, the positional relationship determination unit 58 derives the positional relationship between the major object and the region inappropriate for shooting, based on: the position and the size of the region of the major object in the image; the position and the size of the region inappropriate for shooting; and occupancy of the region of the major object in the region inappropriate for shooting. In the case of the occupancy of the region of the major object in the region inappropriate for shooting being at least a predetermined value, the major object is determined to be within the region inappropriate for shooting.

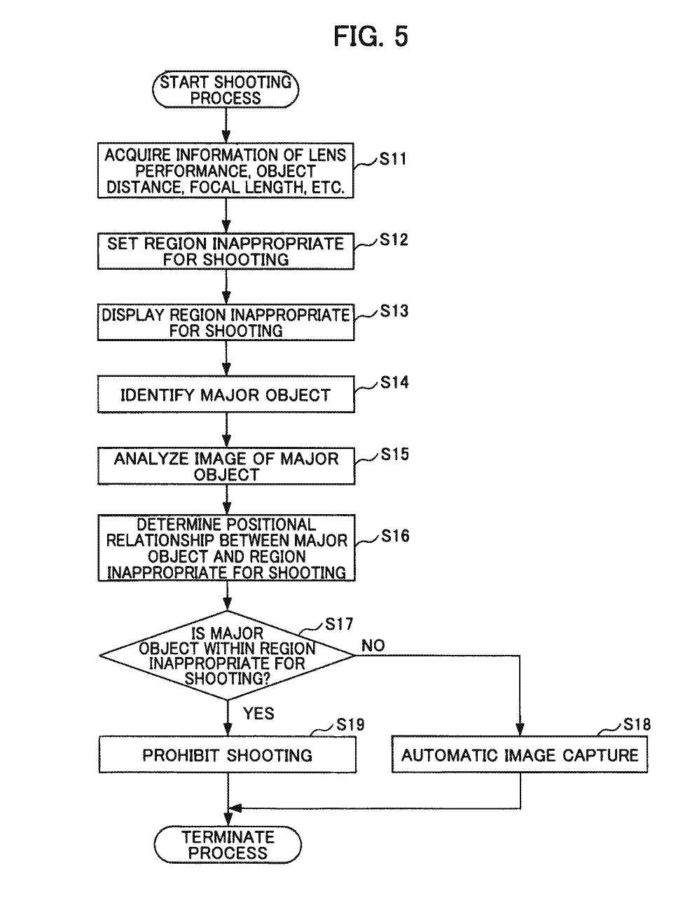

FIG. 5 is a flow chart explaining a flow of the shooting process performed by the image capture apparatus 1 of FIG. 2 having the functional configuration of FIG. 4. The shooting process is triggered by a user's operation on the input unit 18 to start the shooting process.

During the shooting process, the shooting status detection unit 51 detects whether the shooting is stationary shooting or handheld selfie shooting, based on the sensor information acquired from the sensor unit 17.

In the present example, the shooting process is triggered based on a result of detection of the handheld selfie shooting.

In addition, once the shooting process is triggered, the image capture control unit 52 makes the image capture unit 16 execute an image capture process, and live view images are output sequentially to the CPU 11, an image processing unit (not illustrated), etc.

In Step S11, the shooting information acquisition unit 53 refers to the shooting information stored in the shooting information storage unit 71 and acquires information of the lens characteristic, as well as information of the object distance and the focal length resulting from the control of the image capture unit 16.

In Step S12, the inappropriate region setting unit 54 sets the region inappropriate for shooting corresponding to a distance of the object in the current angle of view, based on the object distance acquired from the image capture unit 16 and the lens characteristic.

In Step S13, the output control unit 55 outputs by displaying the region inappropriate for shooting on the output unit 19. On the output unit 19, the region inappropriate for shooting is displayed as the guide frame.

In Step S14, the major object identification unit 56 performs face recognition on the image to thereby identify the major object, namely a human face, among objects within the angle of view.

In Step S15, the image analysis unit 57 analyzes the image and thereby determines the position and the size of the region of the major object in the image.

In Step S16, the positional relationship determination unit 58 determines the positional relationship between the major object and the region inappropriate for shooting. For example, the positional relationship determination unit 58 derives the positional relationship between the major object and the region inappropriate for shooting, based on: the position and the size of the region of the major object in the image; the position and the size of the region inappropriate for shooting; and occupancy of the region of the major object in the region inappropriate for shooting. In the case of the occupancy of the region of the major object in the region inappropriate for shooting being at least a predetermined value, the major object is determined to be within the region inappropriate for shooting.

In Step S17, the positional relationship determination unit 58 determines if the major object is within the region inappropriate for shooting.

In the case of the major object being within the region inappropriate for shooting, the determination in Step S17 is YES and the processing advances to Step S19.

On the contrary, in the case of the major object not being within the region inappropriate for shooting, the determination in Step S17 is NO and the processing advances to Step S18.

In Step S18, the image capture control unit 52 controls the image capture unit 16 to automatically perform the trimming enlarging shooting around the face region detected in the region of the major object.

The shot image is stored in the image storage unit 72.

The shooting process is then terminated.

In Step S19, the image capture control unit 52 performs the shooting prohibition process to control the image capture unit 16, to thereby prohibit shooting.

The shooting process is then terminated.

The present example can be configured such that the shooting process of Steps S11 to S19 is triggered also by a result of detection of the stationary shooting.

### <Modification>

The present modification is configured such that, in the above described embodiment, as a result of the determination in Step S17, the determination result is notified based on the premise that the user performs the shooting operation, instead of automatic shooting and the like.

For example, the present modification is configured such that, in an inappropriate state for shooting such as a state causing distortion, “NG” is displayed for notifying of the inappropriate state for shooting, and an announcement for suggesting the appropriate state for shooting such as “Please step back a little” is output, as illustrated in FIG. 3.

Alternatively, in a case of suggesting the appropriate state for shooting, the modification can be configured to perform shooting assistance by displaying the image while highlighting the distortion and guiding the user to the appropriate position.

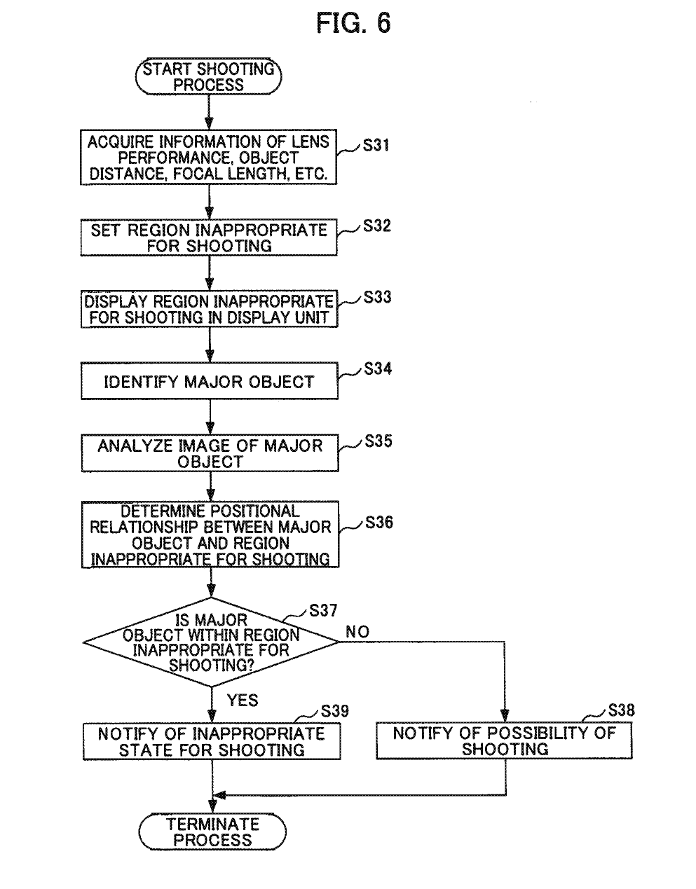

FIG. 6 is a flow chart explaining a flow of another shooting process performed by the image capture apparatus 1 of FIG. 2 having the functional configuration of FIG. 4. Hereinafter, description for Steps S31 to S37 which are similar to Steps S11 to S17 of the above described embodiment is omitted.

In Step S38, the output control unit 55 controls the output unit 19 to notify by outputting that shooting is possible. The output unit 19 notifies by outputting, for example, sound, light, vibration, a message indicating that shooting is possible, and the like. After having checked the notified result, the user performs the shooting operation on the input unit 18 and shoots if the determination result is preferable. The shooting process is then terminated. In this case, the shooting process can be configured such that any one of the trimming enlarging shooting and the regular shooting is performed automatically or based on the user's operation.

In Step S39, the output control unit 55 controls the output unit 19 to notify by outputting that shooting is inappropriate. The output unit 19 notifies by outputting a message indicating that shooting is inappropriate by, for example, sound, light, or vibration. The shooting process is then terminated.

The present example can be configured such that the shooting process of Steps S31 to S39 is triggered also by a result of detection of the stationary shooting.

The image capture apparatus 1 thus configured is provided with: the image capture unit 16; the shooting information acquisition unit 53; the major object identification unit 56; and the positional relationship determination unit 58.

The image capture means 16 captures an image of an object.

The shooting information acquisition unit 53 acquires information relating to optical aberration in the image capture unit 16.

The major object identification unit 56 identifies the major object in the image captured by the image capture unit 16.

A status of the major object identified by the major object identification unit 56 is determined based on the information relating to optical aberration acquired by the positional relationship determination unit 58 and the shooting information acquisition unit 53.

As a result, the image capture apparatus 1 can determine the status of the object appropriate for shooting, that is, a status free from effect of the optical aberration in the image capture unit 16.

The shooting information acquisition unit 53 acquires information of optical distortion in a lens as the information relating to optical aberration.

The positional relationship determination unit 58 determines a position of the major object in the angle of view as the status of the major object.

As a result, the image capture apparatus 1 can determine the status of the object appropriate for shooting, that is, a status not suffering from the optical distortion in the lens.

The image capture apparatus 1 further includes the inappropriate region setting unit 54.

The inappropriate region setting unit 54 identifies a region in the angle of view suffering from the optical distortion in the lens.

The positional relationship determination unit 58 determines the region suffering from the optical distortion in the lens identified by the inappropriate region setting unit 54 and the position of the major object.

As a result, the image capture apparatus 1 can determine the status of the object appropriate for shooting, by determining the region suffering from the optical distortion in the lens and the position of the major object.

The image capture apparatus 1 further includes the shooting information acquisition unit 53.

The shooting information acquisition unit 53 acquires information of distance from the major object.

The positional relationship determination unit 58 determines a distance status of the major object from the image capture unit 16 as the status of the major object.

As a result, the image capture apparatus 1 can determine the status of the object appropriate for shooting, based on the distance status of the major object from the image capture unit 16.

The positional relationship determination unit 58 determines a dimension of the major object occupying the angle of view or a distance from the major object as the distance status of the major object from the image capture unit 16.

As a result, the image capture apparatus 1 can easily determine the status of the object appropriate for shooting, by determining the dimension of the major object occupying the angle of view or the distance from the major object.

The positional relationship determination unit 58 determines that the status of the major object is preferable in the case of the major object being distant from the image capture unit 16.

Given this, the image capture apparatus 1 can determine the status of the object appropriate for shooting, since generation of distortion is less likely when the object is distant.

The image capture apparatus 1 further includes the output control unit 55.

The output control unit 55 controls the output unit 19 to notify of the status of the major object determined by the positional relationship determination unit 58.

The image capture apparatus 1 can thus allow the user to decide whether to shoot or not, by notifying of the status.

The image capture apparatus 1 further includes the output control unit 55.

The output control unit 55 controls the output unit 19 that assists attaining a preferable state if the status of the major object determined by the positional relationship determination unit 58 is not preferable.

By the shooting assistance, the image capture apparatus 1 can allow the user to adjust the position of the object and the like for attaining the state of the object appropriate for shooting.

The image capture apparatus 1 further includes the image capture control unit 52.

The image capture control unit 52 controls the image capture unit 16 to capture the image if the status of the major object determined by the positional relationship determination unit 58 is preferable.

The image capture apparatus 1 can thus automatically capture the image including the object appropriate for shooting.

The major object identification unit 56 identifies a human face as the major object.

The image capture apparatus 1 can thus be specialized in shooting of a human face, such as selfie shooting.

The image capture control unit 52 generates a new image by performing a process of enlarging and trimming a region of the major object from the image captured by the image capture unit 16.

As a result, even in a case of shooting with an angle of view including objects other than the major object, the image capture apparatus 1 can obtain an image composed of the major object.

The determination by the positional relationship determination means 58 takes place in the case of selfie shooting.

The image capture apparatus 1 can thus automatically determine the state of the object appropriate for shooting in the case of selfie shooting.

The image capture apparatus 1 further includes the shooting status detection unit 51.

The shooting status detection unit 51 acquires attitude information relating to attitude of the apparatus.

The shooting status detection unit 51 detects selfie shooting based on the attitude information thus acquired.

The image capture apparatus 1 can thus automatically detect selfie shooting.

The image capture unit 16 captures an image of the object with a wide-angle lens.

As a result, the image capture apparatus 1 can determine the status of the object appropriate for shooting, taking into consideration the lens characteristic of the wide-angle lens.

The image capture apparatus 1 is composed of a first housing 100, a second housing 101, and a frame 102.

The first housing 100 includes the image capture unit 16.

The second housing 101 is connected to the first housing 100 and includes the output unit 19.

The frame 102 is connected to the first housing 100.

The image capture apparatus 1 is thus configured as a housing that allows shooting while checking the display means.

It should be noted that the present invention is not to be limited to the aforementioned embodiments, and that modifications, improvements, etc. within a scope that can achieve the objects of the present invention are also included in the present invention.

The above-described embodiment is configured to acquire the lens characteristic at each shooting process; however, the embodiment can also be configured to acquire the distance information derived from the lens characteristic and then perform the shooting process.

The above-described embodiment can also be configured to determine the distance from the major object and determine whether the distance causes distortion with the lens characteristic derived from the lens performance.

In addition, the above-described embodiment is configured such that the inappropriate region setting unit 54 sets the region inappropriate for shooting corresponding to a distance of the object in the current angle of view in the lens performance, based on the object distance acquired from the image capture unit 16 and the lens characteristic; however, the embodiment can also be configured to set the region inappropriate for shooting by calculating a region suffering from chromatic aberration based on the color information of the object.

In addition, the above-described embodiment is configured such that the positional relationship determination unit 58 judges possibility of shooting based on whether the major object is present within the region inappropriate for shooting; however, the present invention is not limited thereto. Judgment of possibility of shooting can involve further conditions: for example, the embodiment can be configured to judge that shooting is possible in the case of the occupancy of the major object (face) in the angle of view being at least a predetermined value. In the case of stationary shooting, the object is distant from the image capture apparatus 1 and whole body is captured, and occupancy of the major object (face) is expected to be small in the angle of view. A threshold of occupancy used for judgment should thus be low. In this case, the occupancy that allows the trimming enlarging shooting is preferable.

In addition, in the above-described embodiment, the shooting assistance in the case of inappropriate state for shooting can be configured to display the inappropriate state on the actual object, by simulating the exaggerated distortion in the live view image being displayed, instead of simply outputting a message of inappropriate state. Alternatively, in order to guide to a position not suffering from distortion, the shooting assistance can also be configured to sensorially guide to the position by display the position in the angle of view and, in the case of simulating the distortion, reducing the degree of distortion as the object approaches the appropriate position.

In the aforementioned embodiments, explanations are provided with the example of the image capture apparatus 1 to which the present invention is applied being a digital camera; however, the present invention is not limited thereto in particular.

For example, the present invention can be applied to any electronic apparatus in general with a shooting processing function. For example, for example, the present invention can be applied to a laptop personal computer, a printer, a television receiver, a video camera, a portable navigation device, a cell phone device, a smartphone, a portable gaming device, and the like.

The processing sequence described above can be executed by hardware, and can also be executed by software.

In other words, the hardware configurations of FIG. 4 are merely illustrative examples, and the present invention is not particularly limited thereto. For example, the types of functional blocks employed to realize the above-described functions are not particularly limited to the examples shown in FIG. 4, so long as the image capture apparatus 1 can be provided with the functions enabling the aforementioned processing sequence to be executed in its entirety.

A single functional block may be configured by a single piece of hardware, a single installation of software, or a combination thereof.

In a case in which the processing sequence is executed by software, the program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program not only can be constituted by the removable medium 31 shown in FIG. 2 which is distributed separately from the device main body in order to supply the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance may include, for example, the ROM 12 shown in FIG. 2, a hard disk included in the storage unit 20 shown in FIG. 2 or the like, in which the program is recorded.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. An image capture apparatus comprising:
a processor which is configured to:
capture an image of an object;
acquire information relating to optical aberration in the image capture unit;
identify a major object in an image captured by the image capture unit; and
determine a status of the major object based on the information relating to optical aberration.

2. The image capture apparatus according to claim 1, wherein the processor is configured to:
acquire information of optical distortion in a lens as the information relating to optical aberration; and
determine a position of the major object in an angle of view as the status of the major object.

3. The image capture apparatus according to claim 2, wherein the processor is configured to:
identify a region in the angle of view suffering from the optical distortion in the lens,
determine the region suffering from the optical distortion in the lens and the position of the major object.

4. The image capture apparatus according to claim 1, wherein the processor is configured to:
acquire information of distance from the major object,
determine a distance status of the major object from the image capture apparatus as the status of the major object.

5. The image capture apparatus according to claim 4, wherein the processor is configured to:
determine a dimension of the major object occupying the angle of view or a distance from the major object as the distance status of the major object from the image capture apparatus.

6. The image capture apparatus according to claim 4, wherein the processor is configured to determine that the status of the major object is preferable in the case of the major object being distant from the image capture apparatus.

7. The image capture apparatus according to claim 1, wherein the processor is configured to notify the status of the major object.

8. The image capture apparatus according to claim 1, wherein the processor is configured to assist attaining a preferable state if the status of the major object determined to be not preferable.

9. The image capture apparatus according to claim 1, wherein the processor is configured to capture the image if the status of the major object determined is preferable.

10. The image capture apparatus according to claim 1, wherein the processor is configured to identify a human face as the major object.

11. The image capture apparatus according to claim 1, wherein the processor is configured to generate a new image by performing a process of enlarging and trimming a region of the major object from the image captured by the image capture apparatus.

12. The image capture apparatus according to claim 1, wherein the processor is configured to determine a status of the major object based on the information relating to optical aberration. in the case of selfie shooting.

13. The image capture apparatus according to claim 12, wherein the processor is configured to: acquire attitude information relating to attitude of the apparatus; and
detect the selfie shooting based on the attitude information.

14. The image capture apparatus according to claim 1, wherein the processor is configured to capture an image of the object with a wide-angle lens.

15. The image capture apparatus according to claim 1, comprising: a first housing that has the image capture unit;
a second housing that is connected to the first housing and has a display unit; and
a third housing that is connected to the first housing.

16. A determination method performed by an image capture apparatus provided with an image capture unit that captures an image of an object, the method comprising:
acquiring information relating to optical aberration in the image capture unit;
identifying a major object from an image captured by the image capture unit; and
determining a status of the major object based on the information relating to optical aberration.

17. A non-transitory computer readable storage medium encoded with a computer-readable program that enables a computer to execute functions comprising:
acquiring information relating to optical aberration in the image capture unit;
identifying a major object from an image captured by the image capture unit; and
determining a status of the major object based on the information relating to optical aberration.
